(19) United States
(12) Patent Application Publication
(10) Pub. No.: US 2009/0281242 A1
(43) Pub. Date: Nov. 12, 2009

(54) METHOD OF PREPARING A POLYMER FILM HAVING NANOSCALE FEATURES AT THE SURFACE AND THAT IS MICROSTRUCTURED IN ITS THICKNESS OVER ALL OR PART OF THIS FILM IN ACCORDANCE WITH A PARTICULAR SYSTEM

(76) Inventor: Stefan Landis, Voiron (FR)

Correspondence Address: Commissariat a I'Energie Atomique/BHGL, P.O. Box 10395, Chicago, IL, 60610, US

(21) Appl. No.: 12/425,108

(22) Filed: Apr. 16, 2009

(30) Foreign Application Priority Data
Apr. 18, 2008 (FR) 0852647

(51) Int. Cl. C08L 53/00

(52) U.S. Cl. 525/88

(57) ABSTRACT

A method of preparing a polymer film having nanoscale features at the surface and being microstructured in its thickness over all or part of this film in accordance with a particular system including
providing at least one block copolymer capable of being microstructured in accordance with the aforementioned particular system at a predetermined temperature and in accordance with at least one predetermined thickness, where the predetermined thickness corresponds to the thickness of the film all or part of which is compatible with the microstructuring in accordance with the particular system. At least one mould is provided capable of conferring the predetermined thickness and the nanoscale features after application to a film comprising the block copolymer. The mould is applied to a film including the block copolymer while heating the mould to the predetermined temperature, by which means the film is obtained and defined as an article.

### RELATED APPLICATIONS

The present patent document claims the benefit of priority to French Patent Application No. 0852647, filed Apr. 18, 2008, which is incorporated herein by reference.

### TECHNICAL FIELD

The invention relates to a method of preparing a polymer film having nanoscale features at the surface and that is microstructured in its thickness over all or part of this film in accordance with a particular system, this method taking advantage of the ability of block copolymers to be organized in accordance with particular systems.

This method may find its application in the production of supports for very large-capacity information storage (for example, for magnetic hard disks or optical disks), filtration membranes, moulds intended for carrying out nanoimprinting techniques or else for producing interconnections in the microelectronics or nanoelectronics field.

### BACKGROUND

The needs for methods for producing articles that have nanoscale features have greatly increased in the last ten years, due to the tendency towards the miniaturization of components, especially in view of increasing the storage capacity (for example, for magnetic hard disks or optical disks) or else of increasing the quality of certain devices (such as digital cameras, flat screens, and the like).

Conventionally, these articles are produced by lithography, namely by techniques that make it possible to reproduce, in a resin deposited on the surface of a material, the feature that it is desired to print.

Various printing tools can be used, among which mention may be made of:

a light beam, in which case it is known as optical lithography;

a beam of electrons, in which case it is known as electron beam lithography; or else

a beam of ions, in which case it is known as ion beam lithography.

Although these techniques make it possible to produce nanoscale features at the surface of a resin, they do not however induce the specific microstructuring of the resin in its thickness.

It is found that, for certain applications, it may prove important, besides the fact of producing nanoscale features, to at the same time give the material serving as a base for the production of the features a specific microstructure in its thickness, such as a lamellar system, a spherical system, a cylindrical system or a micellar system.

There is therefore a real need for a method that makes it possible to obtain a polymer film having, at its surface, nanoscale features and a microstructure in accordance with a particular and sought-after system depending on the subsequent application of the film, in its thickness and over all or part of this film.

### SUMMARY

The authors of the invention have advantageously discovered that by using a particular type of polymer for the composition of the film and a particular technique for printing the features it was possible to produce nanoscale features on a film, while giving said film a microstructure in accordance with one particular system in its thickness and over all or part of this film.

Thus, the invention relates to a method of preparing a polymer film having nanoscale features at the surface and being microstructured in its thickness over all or part of this film in accordance with a particular system comprising the following steps:
a step of choosing at least one block copolymer capable of being microstructured in accordance with the aforementioned particular system at a predetermined temperature and in accordance with at least one predetermined thickness, said predetermined thickness corresponding to the thickness of the film for all or part of which the microstructuring in accordance with the aforementioned particular system is desired;
a step of choosing at least one mould capable of conferring, after application to a film comprising said block copolymer, the predetermined thickness and said nanoscale features; and
a step of applying said mould to a film comprising said block copolymer while heating it to said predetermined temperature, by means of which said film, defined as an article, is obtained.

Before going into more detail in the description, the following definitions are proposed.

The expression “nanoscale features” is conventionally understood to mean a structure in relief, at least one of the dimensions of which (height, length and/or width) may range from 1 to 100 nm.

Particular examples of nanoscale features may be trenches, hollows of rectangular, circular or square shape, concentric structures.

The expression “microstructure” is conventionally understood to mean the way in which the constituent components of a material are organized in a geometrical fashion, at a scale where they can only be observed by microscopy or specialized techniques (such as scanning electron microscopy).

The expression “thickness” is conventionally understood to mean the measurement of the dimension of the film reflecting the part located between the two surfaces of the film, namely the lower surface and the upper surface of this film. In this case, the film obtained by the method of the invention does not have a uniform thickness due to the presence of nanoscale features.

Thus, a person skilled in the art wishing to obtain a film having particular nanoscale features and a particular microstructuring in its thickness over all or part of this film will begin by choosing the block copolymer, this choice being made so that said copolymer can exhibit the desired microstructuring for at least one predetermined film thickness (after a heat treatment at the predetermined temperature), said predetermined film thickness corresponding to that of the film for which it is desired to obtain a microstructuring over all or part of this film. Once the block copolymer is chosen, the suitable mould will be chosen that is capable of conferring, by application of this mould to a film comprising said block copolymer, both the nanoscale features and the desired thickness.

The authors have thus taken advantage of the organizational properties of block copolymers.

It is stated that the expression “block copolymer” is understood to mean a polymer that comprises at least one first block and at least one second block, said first block and said second block being of a different chemical nature joined together by a covalent bond. Under the action of the temperature and for a given film thickness, the copolymer chains gain mobility and end up being segregated, thus leading to “heterocontacts” between the segments of different chemical nature being minimized. For a predetermined temperature and a predetermined thickness, the resulting films will exhibit, in their thickness, an organized microstructure which may correspond to a particular system.

The predetermined thickness may be between 1 nm and 1 μm and the temperature may be between 20° C. and 250° C.

The system, in accordance with which the film may be completely or partly microstructured depending on its thickness, may be a lamellar system, a cylindrical system, a spherical system or a micellar system.

It is stated that the expression “lamellar system” is understood to mean a system for organizing the constituent components of the film, which are visible, for example, by scanning electron microscopy imaging, so that these components appear in the form of aligned lamellae.

It is stated that the expression “cylindrical system” is understood to mean a system for organizing the constituent components of the film, which are visible, for example, by scanning electron microscopy imaging, so that these components appear in the form of cylinders.

It is stated that the expression “spherical system” is understood to mean a system for organizing the constituent components of the film, which are visible, for example, by scanning electron microscopy imaging, so that these components appear in the form of spheroids.

It is stated that the expression “micellar system” is understood to mean a system for organizing the constituent components of the film, which are visible, for example, by scanning electron microscopy imaging, so that these components appear in the form of micelles.

Such systems are represented in FIG. 1, where: Such systems are represented in FIG. 1, where:

FIG. 1(a) illustrates a lamellar system where the lamellae 1 are arranged parallel to the plane of an underlying reference substrate 3;

FIG. 1(b) illustrates a lamellar system where the lamellae 5 are arranged perpendicular to the plane of an underlying reference substrate 7;

FIG. 1(c) illustrates a cylindrical system where the cylinders 9 are arranged parallel to the plane of an underlying reference substrate 11;

FIG. 1(d) illustrates a cylindrical system where the cylinders 13 are arranged perpendicular to the plane of an underlying reference substrate 15;

FIG. 1(e) illustrates a spherical system where the spheroids 17 are arranged in the film 19 in accordance with a hexagonal lattice.

The systems may vary depending on the temperature treatment applied and the given thickness of the film.

When it is desired to obtain a film that may have a lamellar system, it will be possible, after having optionally determined the appropriate temperature and the appropriate thickness for obtaining such a system (if such data are not already available), to choose the block copolymers from the following:

PS-b-PBMA, PS-b-PMMA, PS-b-P2VP, PB-b-PEO, PS-b-PB, PS-b-PI-b-PS, PVPDMPS-b-PI-b-PVPDMPS, PS-b-P2VP-b-PtBMA,

PS signifying polystyrene, PBMA signifying poly(n-butyl methacrylate), PMMA signifying polymethyl methacrylate, P2VP signifying poly(2-vinylpyridine), PB signifying polybutadiene, PEO signifying polyethylene oxide, PVPDMPS signifying poly(4-vinylphenyldimethyl-2-propoxysilane), PI signifying polyisoprene, PtBMA signifying poly(t-butyl methacrylate)

When it is desired to obtain a film that may have a cylindrical system, it will be possible, after having optionally determined the appropriate temperature and the appropriate thickness for obtaining such a system (if such data are not already available), to choose the block copolymers from the following:

PFDMS-b-PDMS, PS-b-P2VP, PS-b-PMMA, PS-b-PEP, PS-b-PE, PS-b-PB, PS-b-PEO, PS-b-PB-b-PS, PαMS-b-PHS, PS-b-PI, PI-b-PFDMS, PS-b-PFDMS, PS-b-PFEMS, PtBA-b-PCEMA, PS-b-PLA, PCHE-b-PLA, PαMS-b-PHS, PPDS-b-P4VP, PFDMS signifying poly(ferrocenyldimethylsiloxane),

PDMS signifying polydimethylsiloxane, PS signifying polystyrene, P2VP signifying poly(2-vinylpyridine), PMMA signifying polymethyl methacrylate, PEP signifying poly(ethylene-alt-propylene), PE signifying polyethylene, PEO signifying polyethylene oxide, PB signifying polybutadiene, PαMS signifying poly(α-methylstyrene), PHS signifying poly(4-hydroxystyrene), PI signifying polyisoprene, PFEMS signifying poly(ferrocenylethylmethylsilane), PtBA signifying poly(tert-butyl acrylate), PCEMA signifying poly(cinnamoyl-ethylmethacrylate), PLA signifying polylactide, PCHE signifying polycyclohexylethylene, PPDS signifying pentadecylphenol-modified polystyrene, P4VP signifying poly(4-vinylpyridine).

The term “alt” is understood to mean a polymer having alternate repeat units. For example, poly(ethylene-alt-propylene) is understood to mean a polymer having, in its backbone, an alternation between ethylene units and propylene units.

When it is desired to obtain a film that may have a spherical system, it will be possible, after having optionally determined the appropriate temperature and the appropriate thickness for obtaining such a system (if such data are not already available), to choose the block copolymers from the following:

PS-b-PMMA, PS-b-P2VP, PS-b-PFDMS, PS-b-PI, PS-b-PtBA, polylysine-b-polycysteine,

PS signifying polystyrene, PMMA signifying polymethyl methacrylate, P2VP signifying poly(2-vinylpyridine), PFDMS signifying poly(ferrocenyldimethylsiloxane), PI signifying polyisoprene, PtBA signifying poly(t-butyl acrylate).

When it is desired to obtain a film that may have a micellar system, it will be possible, after having optionally determined the appropriate temperature and the appropriate thickness for obtaining such a system (if such data are not already available), to choose the block copolymers from the following:

PS-b-P2VP, PEO-b-PPO-b-PEO, PB-b-PVP, PPQ-b-PS, PDOPPV-b-PS, PS-b-PPP,

PS signifying polystyrene, P2VP signifying poly(2-vinylpyridine), PEO signifying polyethylene oxide, PPO signifying polypropylene oxide, PB signifying polybutadiene, PVP signifying poly(butadiene-b-vinylpyridinium), PPQ signifying polyphenylquinoxaline, PDOPPV signifying poly(2,5-dioctyl-p-phenylenevinylene), PPP signifying polyparaphenylene.

Once the step of choosing the block copolymer is carried out, a choice is made as to the mould to be used, so that the application of the mould to a film comprising said block copolymer gives the film the desired nanoscale features and the required thickness, it being known that the mould will have to give the film at least a predetermined thickness for which the film will exhibit a structuring in accordance with a desired system after application of the appropriate temperature (known as the predetermined temperature). In other words, the mould will be chosen so that its topography meets the targeted needs for organizing the polymer film.

The method of the invention may also comprise, when it is not available, a step of producing the mould, this mould possibly being produced by conventional lithography techniques (optical, electron beam, X-ray, ion beam or ASM tip lithography), the mould being produced so as to be able to confer, after application, the required nanoscale features and the required thickness on the film that it is desired to obtain.

The mould may advantageously be sized so that the film obtained after application of said mould does not have grain boundaries, that is to say that the orientation of the crystal lattice planes between two grains does not differ. Prior tests to obtain this effect may be carried out before implementing the method of the invention.

Finally, the method will comprise a step of applying said chosen mould to the film, the temperature being brought to a predetermined temperature, this temperature being necessary for the microstructuring of the film in accordance with the expected system. This application step may be qualified as a nanoimprinting step.

Before the application step, the method of the invention may comprise a step of depositing the film comprising the block copolymer onto a substrate in accordance with conventional deposition techniques.

In accordance with the method of the invention, it may also be possible to envisage using two different moulds, which may be applied so as to clamp the film.

In summary, from a practical point of view, the strategy of implementing the method may be the following:

depending on the targeted application and therefore on the desired microstructure, a block (diblock, triblock, etc.) copolymer will be chosen that is capable of exhibiting the microstructure in accordance with the system that it is desired to obtain;

once the polymer is chosen, if the user does not know for which thickness(es) and temperature the polymer is capable of forming the aforementioned microstructure, he will then be able to set up a first experiment, in order to determine these data (thickness(es) and temperature); to do this, the polymer will be deposited on a flat substrate in the form of a film (without imprinting them), while carrying out the conventional thermodynamic method (by heating at various temperatures). It is possible to carry out this experiment with several polymer thicknesses in order to thus determine the pairs of values (thickness, treatment temperature) that make it possible to attain the required microstructure. The thickness data will subsequently make it possible to determine the design rules for the manufacture, if necessary, of the mould;

where appropriate, the production of the mould, advantageously made of silicon or silica (lateral resolution, depth, shape of the features); since the design rules are known, the manufacture is carried out with conventional lithography techniques (optical lithography, electron beam lithography, X-ray lithography, ion beam lithography);

the application of the mould to the film, optionally deposited on a substrate.

Thus, the method of the invention comprises the following advantages:

possibility of controlling the spatial extension and the position of the microstructured zones in accordance with the required system by virtue of the choice of the appropriate mould and block copolymer;

possibility of controlling, locally and over a large surface (which may correspond to the surface of the mould or to a surface below this mould in accordance with the desired objective), the thickness of the polymer film, and consequently the resulting microstructure, after heat treatment, of the thickness conferred on the film by the application of the mould;

possibility of reusing the mould a very large number of times, unlike the graphoepitaxy technique, for example, where the mould is only used once.

The method of the invention therefore makes it possible to overcome the drawbacks of the techniques used in the prior art, such as:

the technique of graphoepitaxy, which requires that the film to be structured is deposited on a substrate having a topography, this technique is shown to be expensive since the aforementioned substrate can only be used once;

the technique that consists in providing the microstructuring of the polymers in accordance with one particular system, by virtue of the use of an electric field, this technique proving ineffective for organizing the microstructure of a polymer over large surfaces.

Other advantages and characteristics of the invention will appear on reading the particular embodiments, with reference to the appended figures.

### BRIEF DESCRIPTION OF THE DRAWINGS

FIG. 1 illustrates various systems according to which a block polymer may organize itself.

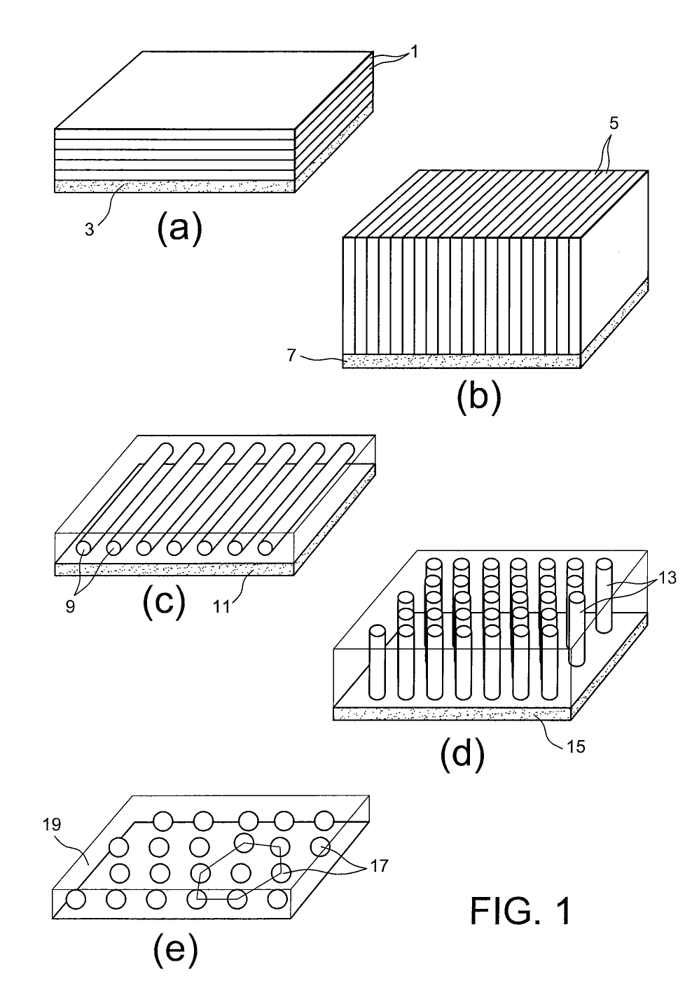

FIG. 2 is a cross-sectional diagram or the various steps in accordance with one particular embodiment of the invention.

FIGS. 3 and 4 illustrates two configurations of different moulds in accordance with an aspect of the invention.

FIG. 5 illustrates a second embodiment of the invention making use of two moulds (cross-sectional view).

FIG. 6 illustrates a variant making use of two complex moulds (cross-sectional view) in accordance with an aspect of the invention.

FIG. 7 illustrates an example of the application of the method of the invention to the production of electronic interconnections in accordance with an aspect of the invention.

### DETAILED DESCRIPTION OF PARTICULAR EMBODIMENTS

Various embodiments are described of the method centred especially on the configuration of the moulds used and the number of these moulds.

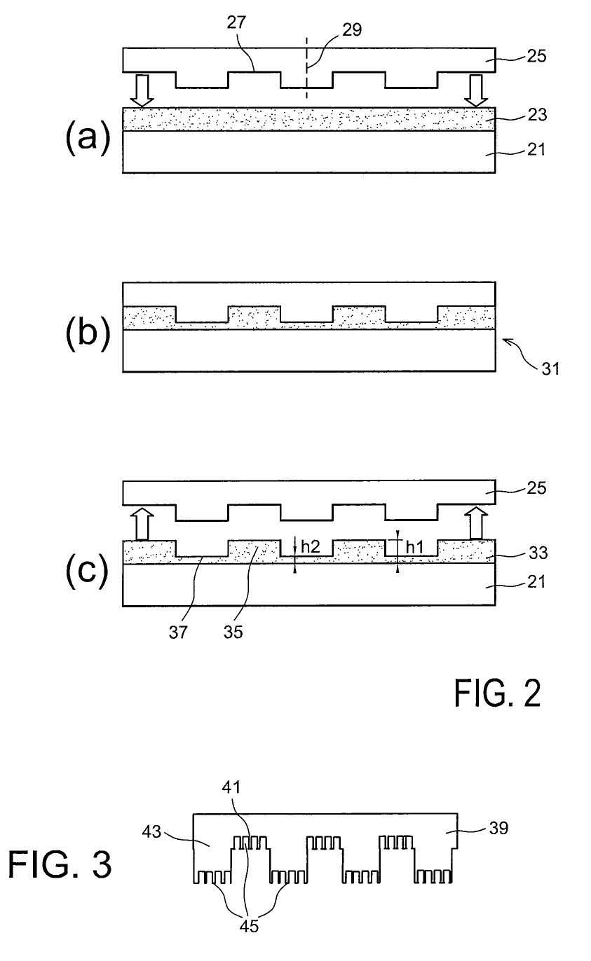

The first embodiment will initially be described. Represented in FIG. 2 are the various steps of the method of the invention using a single mould, with:

in FIG. 2a, a substrate 21 covered with a film 23 comprising a block copolymer and a mould 25 comprising two types of features (respectively feature 27 and feature 29), this mould exhibiting, in cross section, a crenellated profile;

in FIG. 2b, the assembly 31 formed of the substrate, the film and the mould after application of the latter to the film; and

in FIG. 2c, the substrate 21 covered with the film 33 modified after application of the mould 25, this film exhibiting two types of features 35 and 37, respectively conferring on the film a high thickness h1 and a low thickness h2.

The thus imprinted film may correspond to various possible configurations:

a microstructuring in accordance with one particular system (for example, a lamellar system) over the whole film, the mould making it possible to confer a thickness that enables the required system to be maintained over the entirety of the film, the thickness having dimensions that are multiples of one another, in order to conserve the periodicity of the organization;

a microstructuring in accordance with one particular system (for example, a lamellar system) under a feature (high thickness h1 or low thickness h2) and a lack of organization in accordance with one particular system under another feature (high thickness h1 or low thickness h2);

a microstructuring in accordance with one particular system (for example, a lamellar system) under a feature (for example, high thickness h1) and a microstructuring in accordance with another system (for example, a cylindrical system) under another feature (for example, low thickness h2), this configuration being made possible by the use of a block copolymer capable of adopting two different crystalline systems for two different film thicknesses for a heat treatment at one and the same temperature (which is the case, for example, for PS-b-PMMA).

Thus, by choosing the dimensions of the aforementioned features 35 and 37 and considering the characteristics of the constituent block copolymer of the film, it is thus possible to perfectly control the spatial extension and the position of the microstructured zones in accordance with a required system.

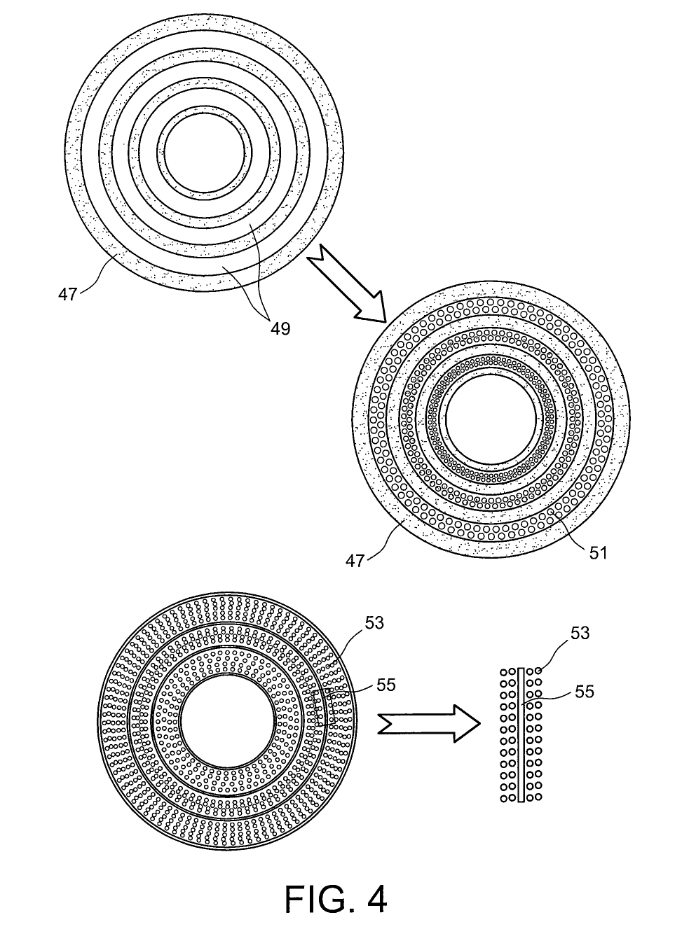

FIGS. 3 and 4 represent two variants that use a single mould:

in FIG. 3, a mould 39 exhibiting, in cross section, a crenellated profile, the hollows 41 and the peaks 43 of which are provided with ridges 45;

in FIG. 4, a circular mould 47 exhibiting concentric moulding spaces 49.

In the first case, the method makes it possible to obtain a film having nanoscale features comprising at least two topographic levels: a first level consisting of the crenellated profile and the second level consisting of the ridges made in the peaks and hollows of the first level. The film may be microstructured in accordance with a suitable system over the entirety of this film (for example, lamellar system) or only over certain zones (for example, in accordance with the high or low thickness of the film).

In the second case, besides the concentric features obtained, the use of the method of the invention with this type of mould makes it possible to obtain a film that is microstructured in accordance with one particular system and that has a very high density of zones that are microstructured in accordance with the required system (for example, greater than 1 terabit/inch²) (reference 51 in FIG. 4). By reducing the size of the unorganized zones in the desired system, it is also possible to achieve an organization of the domains which, relative to one another, will exhibit a microstructured phase in the desired system with a minimization of the grain boundary zones (see FIG. 4, which represents the concentric zones organized in accordance with the required system 53 and the unorganized zones 55 of very limited size). Producing supports for very large-capacity information storage (magnetic or optical storage) may thus be envisaged.

In accordance with a second embodiment, the use of two moulds is undertaken, the polymer film being clamped between these two moulds.

These moulds may be identical, as is represented:

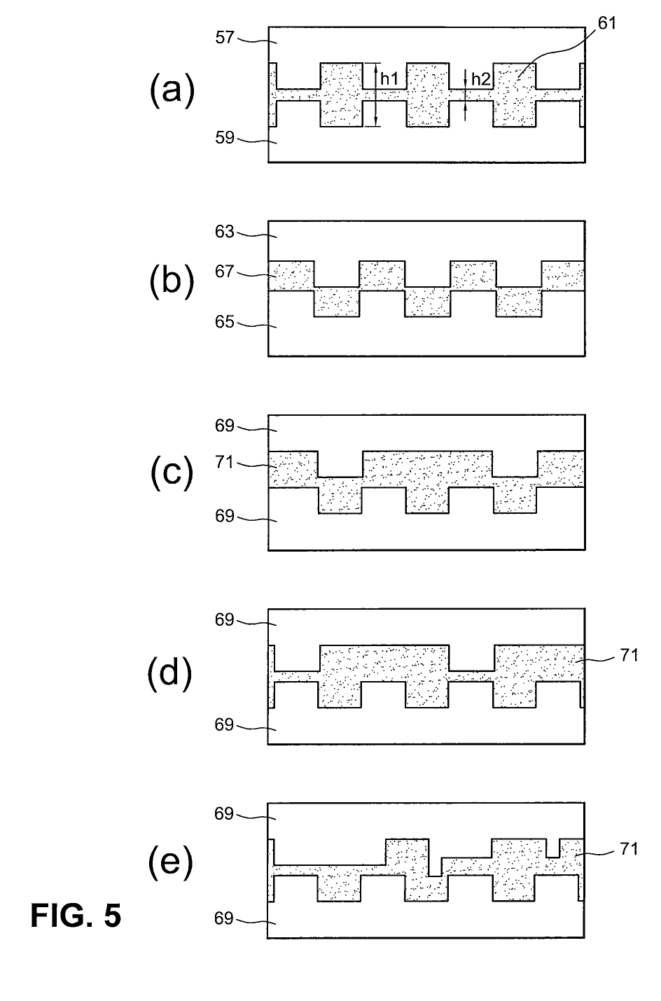

in FIG. 5a, where two identical moulds 57 and 59 are arranged opposite each other and clamp a polymer film 61, thus generating features having heights h1 and h2 that are microstructured in accordance with a desired crystalline system;

in FIG. 5b, where two identical moulds 63 and 65 are arranged in an offset manner on both sides of a polymer film 67.

These moulds may be different, as is represented in FIGS. 5c to 5d (references 69 for the moulds and 71 for the film).

It thus emerges from this embodiment that it is possible to create an infinite number of possible configurations and of domains organized in accordance with a required crystalline system, subject to choosing the appropriate block copolymer that is capable of crystallizing in accordance with the required system for the feature thicknesses conferred by the moulds.

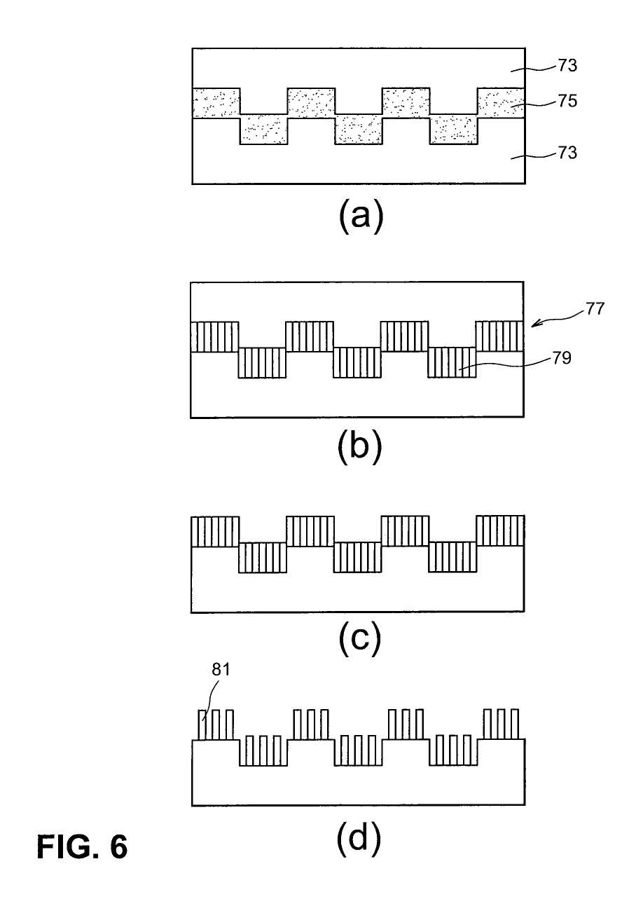

One particular example of the use of two moulds for creating complex features is represented in FIG. 6 where:

in FIG. 6a, two identical moulds 73 clamp a polymer film 75 composed of two block copolymers capable of crystallizing in accordance with a lamellar system for the feature thicknesses conferred by the application of the two moulds;

in FIG. 6b, the assembly 77 formed by the two moulds and the clamped film, this assembly being brought to a predetermined temperature in order to crystallize the film in accordance with a lamellar system 79;

in FIG. 6c, the removal of the upper mould 73;

in FIG. 6d, the selective removal of one polymer with respect to the other, thus allowing nanoscale features 81 to remain.

It may be possible, in accordance with the method of the invention, to etch the geometry created in the polymer film into the substrate which bears the film.

The method of the invention may be used in very many fields of application, among which mention may be made of:

the production of supports for information storage (such as magnetic storage, optical storage);

the production of parts having a textured surface, especially for modifying its wettability properties (for example, for self-cleaning glass), adhesion properties or for biological applications;

the production of membranes having nanopores for filtration systems;

the production of moulds, especially for the implementation of imprinting techniques, such as nanoimprinting;

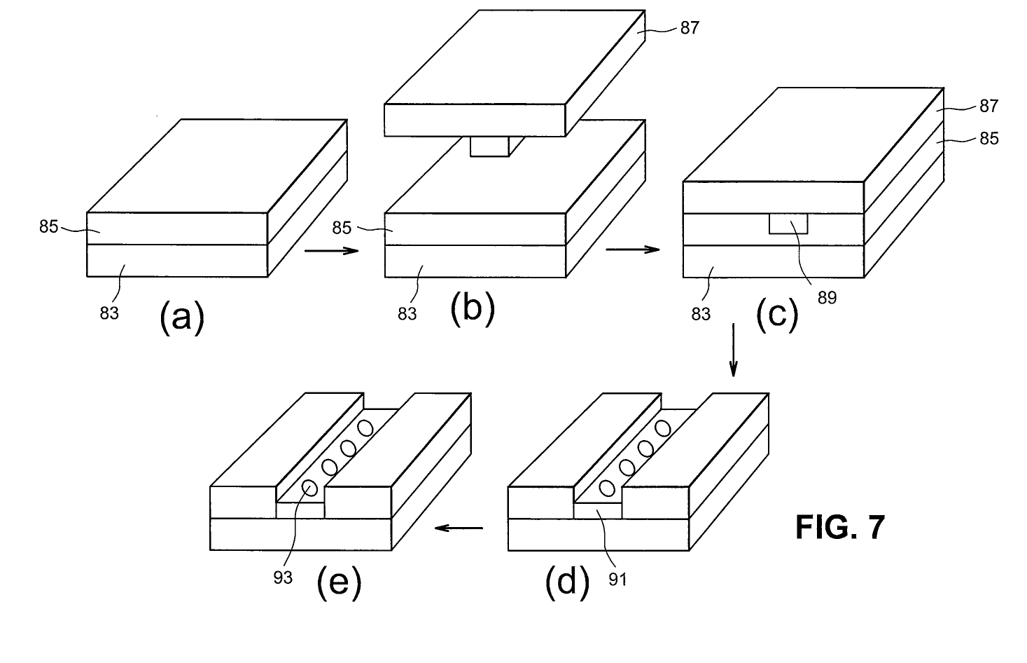

the production of interconnections for electronic applications, this application being represented in FIG. 7.

More precisely, FIG. 7 represents the various steps for producing interconnections intended to connect a lower dielectric level to conductive elements.

Thus, represented in FIG. 7a is a substrate 83 that constitutes the dielectric level intended to be connected to conductive elements, covered by a film 85 composed of a blend of two diblock copolymers, for which one of the copolymers is capable of being microstructured for a predetermined thickness (here the thickness under the feature generated by the application of the mould) and a predetermined temperature in accordance with one particular system, in this case here a spherical system (that is to say one of the polymers is organized in the form of spheroids).

Applied to this film 85 is, conforming to what is represented in FIGS. 7b and 7c, a mould 87 intended, after application, to form a feature in the shape of a central bay 89 in the film, the assembly being heated at the predetermined temperature necessary for the microstructuring of one of the polymers in accordance with a spherical system.

The mould is then removed and the result is, under the feature in the shape of a central bay, a partial microstructuring of the film in accordance with a spherical system (reference 91 in FIG. 7d). The polymer responsible for this microstructuring is then removed via an appropriate treatment, allowing through-holes 93 to remain (FIG. 7e), these holes making it possible to produce connector contacts, for example, by filling the cavities thus formed with a conductive element.

1. A method of preparing a polymer film having nanoscale features at the surface and being microstructured in its thickness over all or part of the polymer film in accordance with a particular system, the method comprising the following steps:
providing at least one block copolymer capable of being microstructured in accordance with the particular system at a predetermined temperature and in accordance with at least one predetermined thickness, where the predetermined thickness corresponds to a thickness of the film all or part of which is compatible with microstructuring in accordance with the particular system is desired;
providing at least one mould capable of conferring, after application to a film comprising the block copolymer, the predetermined thickness and said nanoscale features; and
the mould to a film comprising the block copolymer while heating the mould to said predetermined temperature, by means of which the film is obtained, and defined as an article.

2. The method according to claim 1, wherein the particular system comprises a lamellar system, a cylindrical system, a spherical system, or a micellar system.

3. The Method according to claim 2, wherein the particular system comprises a lamellar system, and the block copolymer comprises
PS-b-PBMA, PS-b-PMMA, PS-b-P2VP, PB-b-PEO, PS-b-PB, PS-b-PI-b-PS, PVPDMPS-b-PI-b-PVPDMPS, or PS-b-P2VP-b-PtBMA,
wherein, PS signifies polystyrene, PBMA signifies poly(n-butyl methacrylate), PMMA signifies polymethyl methacrylate, P2VP signifies poly(2-vinylpyridine), PB signifies polybutadiene, PEO signifies polyethylene oxide, PVPDMPS signifies poly(4-vinylphenyldimethyl-2-propoxysilane), PI signifies polyisoprene, and PtBMA signifies poly(t-butyl methacrylate).

4. The Method according to claim 2, wherein the particular system comprises a cylindrical system, and the block copolymer comprises
PFDMS-b-PDMS, PS-b-P2VP, PS-b-PMMA, PS-b-PEP, PS-b-PE, PS-b-PB, PS-b-PEO, PS-b-PB-b-PS, PαMS-b-PHS, PS-b-PI, PI-b-PFDMS, PS-b-PFDMS, PS-b-PFEMS, PtBA-b-PCEMA, PS-b-PLA, PCHE-b-PLA, PαMS-b-PHS, or PPDS-b-P4VP,
wherein PFDMS signifies poly(ferrocenyldimethylsiloxane), PDMS signifies polydimethylsiloxane, PS signifies polystyrene, P2VP signifies poly(2-vinylpyridine), PMMA signifies polymethyl methacrylate, PEP signifies poly(ethylene-alt-propylene), PE signifies polyethylene, PEO signifies polyethylene oxide, PB signifies polybutadiene, PαMS signifies poly(α-methylstyrene), PHS signifies poly(4-hydroxystyrene), PI signifies polyisoprene, PFEMS signifies poly(ferrocenylethylmethylsilane), PtBA signifies poly(tert-butyl acrylate), PCEMA signifies poly(cinnamoyl-ethylmethacrylate), PLA signifies polylactide, PCHE signifies polycyclohexylethylene, PPDS signifies pentadecylphenol-modified polystyrene, and P4VP signifies poly(4-vinylpyridine).

5. The Method according to claim 2, wherein the particular system comprises a spherical system, and the block copolymer comprises
PS-b-PMMA, PS-D-P2VP, PS-b-PFDMS, PS-b-PI, PS-b-PtBA, or polylysine-b-polycysteine,
wherein PS signifies polystyrene, PMMA signifies polymethyl methacrylate, P2VP signifies poly(2-vinylpyridine), PFDMS signifies poly(ferrocenyldimethylsiloxane), PI signifies polyisoprene, and PtBA signifies poly(t-butyl acrylate).

6. The Method according to claim 2, wherein the particular system comprises a micellar structure, and the block copolymer comprises
PS-b-P2VP, PEO-b-PPO-b-PEO, PB-b-PVP, PPQ-b-PS, PDOPPV-b-PS, or PS-b-PPP,
wherein PS signifies polystyrene, P2VP signifies poly(2-vinylpyridine), PEO signifies polyethylene oxide, PPO signifies polypropylene oxide, PB signifies polybutadiene, PVP signifies poly(butadiene-b-vinylpyridinium), PPQ signifies polyphenylquinoxaline, PDOPPV signifies poly(2,5-dioctyl-p-phenylenevinylene), and PPP signifies polyparaphenylene.

7. The Method according to claim 1, further comprising producing the mould.

8. The Method according to claim 7, wherein the mould is sized so that the film obtained after applying the mould is substantially free of grain boundaries.
